(19) United States
(12) Patent Application Publication
(10) Pub. No.: US 2006/0254324 A1
(43) Pub. Date: Nov. 16, 2006

(54) Lock and Carry System and Device for Doors

(76) Inventor: Norman L. Clifton, American Fork, UT (US)

Correspondence Address: STARKWEATHER & ASSOCIATES, 9035 SOUTH 1300 EAST, SUITE 200, SANDY, UT, 84094, US

(21) Appl. No.: 11/382,463

(22) Filed: May 9, 2006

Related U.S. Application Data
(60) Provisional application No. 60/681,223, filed on May 13, 2005.

(51) Int. Cl. E05B 73/00

(52) U.S. Cl. 70/14

(57) ABSTRACT

A lock and key system and device for doors. It is a removable door locking system or lock and carry kit, including: a door blank disposed in a door frame; a first elongated member passing through the latch hole and extend therefrom; a second elongated member disposable in the lock body hole and extending therefrom; a flange extending radially from a first end of the elongated member and stops passage of the first end through the lock body hole of the door; an aperture through the second elongated member; and/or a detachable lock coupleable to the aperture and stops passage of the second end through the lock body hole when coupled to the aperture. The door blank may include a lock body hole through the door blank that receives a lock body and a latch hole through the door blank and in communication with the lock body hole.

This invention claims priority, under 35 U.S.C. §120, to the U.S. Provisional Patent Application No. 60/681,223 to Norman L. Clifton filed on May 13, 2005, which is incorporated by reference herein.

### BACKGROUND OF THE INVENTION

1. Field of the Invention

The present invention relates to door accessories, specifically to door lock and carry systems and devices.

2. Description of the Related Art

During construction of buildings it is generally accepted that doors are installed in the final stages of construction. Having door frames but not doors provides workers with easier access to all portions of a building and generally speeds up the building process, especially in the final stages. However, there are times when doors are needed and/or wanted. Examples include: in the evening for security, to restrict air flow from one room to another, to reduce noise pollution from one portion of a facility to another, etc. Further, similar considerations are present during remodeling, painting, etc.

To accommodate such needs it is known to prematurely install one or more doors, to hang a covering such as a plastic sheet over a door frame, and to lean a substantially planar material against a door frame to block the frame. Other examples of attempts to provide temporary portions of doors include the following patents which are hereby incorporated by reference herein:

U.S. Pat. No. 5,325,685 to Frank discloses a portable auxiliary door lock including a lock cylinder slidable upon a bar having toothed edges to engage the locking means within the cylinder. The device differs from such locks for sliding panels, as it provides for temporary attachment between the edge of an arcuately hinged door and the adjacent door jamb to secure the door when it is closed. One end of the bar is bent at a 90 degree angle to insert into the latch recess of the striker plate. However, rather than using the lock cylinder to abut against the door and thereby at least partially blocking access to the lock cylinder for actuation due to the adjacent door knob assembly, the cylinder faces away from the knob assembly and an additional stop plate is used to retain the door. Other improvements are provided, such as adjustment for the spacing between the door and the jamb and additional security to preclude the forced removal of the lock cylinder from the bar.

Further, U.S. Pat. No. 4,046,185 to Bruning discloses a temporary door installation for a grain carrying freight car wherein the pry board is upwardly tapered to eliminate the need for special sealing.

However, these solutions fail to provide a system and/or device facilitating a sturdy temporary door that is easily installed and easily removed.

What is needed is a door system and/or device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been filly solved by currently available door systems and/or devices. Accordingly, the present invention has been developed to provide a lock and carry system or kit for doors.

In one embodiment of the invention, there is a removable door locking system or lock and carry kit, including one or more of the following: a door blank configured to be disposed in a door frame; a first elongated member configured to pass through the latch hole and extend therefrom; a second elongated member disposable in the lock body hole and configured to extend therefrom; a flange extending radially from a first end of the elongated member and configured to stop passage of the first end through the lock body hole of the door; an aperture through the second elongated member; and/or a detachable lock coupleable to the aperture and configured to stop passage of the second end through the lock body hole when coupled to the aperture.

In another embodiment the door blank may include a lock body hole through the door blank and configured to receive a lock body and/or a latch hole through the door blank and in communication with the lock body hole.

In still another embodiment, the elongated member may include a first end shaped to substantially prevent egress of the first elongated member from the latch hole through the lock body hole when the first end is disposed in the lock body hole and/or a second end disposable through the lock body hole.

In a further embodiment, there may be a flexible member coupled to the second end and configured to facilitate threading the second elongated member through the lock body hole.

In a still further embodiment, there may be a door fitting slot disposed on an exterior surface of the first end.

In yet another embodiment, the first elongated member may include a plurality of telescoping members disposable in an extended and a retracted position. The first elongated member may further have a spring disposed within the plurality of telescoping members. The spring may bias the telescoping members in the extended position.

In a still yet further embodiment, there may be one or more eyelets coupled to the first and/or second elongated members. Such eyelets may provide anchoring for straps, thongs, key-chains, mechanical coupling, clips, hooks, etc.

Reference throughout this specification to features, advantages, or similar language does not imply that all of the features and advantages that may be realized with the present invention should be or are in any single embodiment of the invention. Rather, us language referring to the features and advantages is understood to mean that a specific feature, advantage, or characteristic described in connection with an embodiment is included in at least one embodiment of the present invention. Thus, discussion of the features and advantages, and similar language throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more filly apparent from the following description and appended claims, or may be learned by the practice of the invention as set forth hereinafter.

### BRIEF DECEPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a side perspective view of a rod-shaped member 100 according to one embodiment of the invention;

FIG. 2 illustrates a side perspective view of a bolt 200 according to one embodiment of the invention;

FIG. 3 illustrates an exploded view of a bolt 200 according to one embodiment of the invention;

FIG. 4 illustrates a perspective view of a lock and carry system being placed in operation according to one embodiment of the invention; and

FIG. 5 illustrates a perspective view of a lock and carry system for a door according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

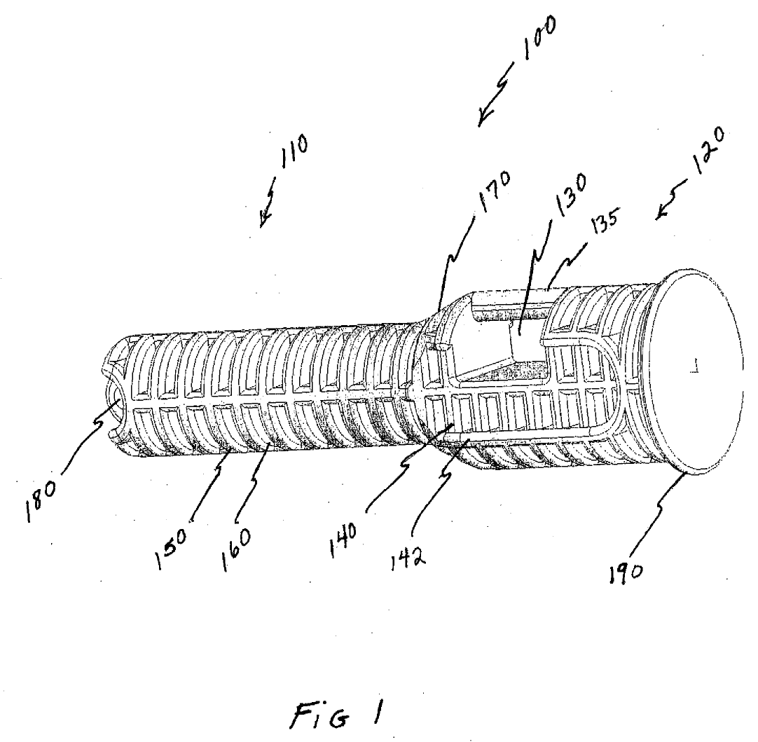

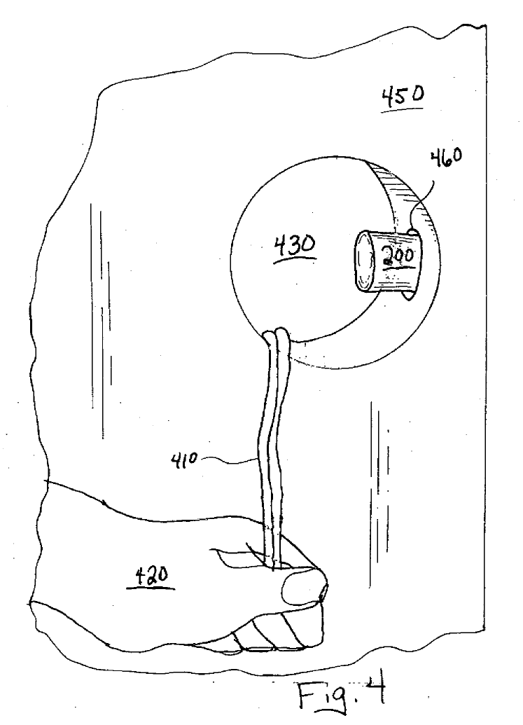

FIG. 1 shows a side perspective view of a rod-shaped member or second elongated member 100 according to one embodiment of the invention. The illustrated rod-shaped member 100 is generally cylindrical. There is a first end or door fitting portion 120 and a second end or handle 110. The first end is shaped to substantially prevent egress of a first elongated member 200 (See FIG. 4) from a latch hole 460 (See FIG. 4) when the first end 120 is disposed in a lock body hole 430 (See FIG. 4).

The illustrated handle portion 1 10 is smaller in radius than the door fitting portion 120 and is shaped and sized to be disposable through an associated lock body hole 430, such as a standard sized lock body hole for a particular type of door. There is also shown a cavity or aperture 130 through the second elongated member 100. The illustrated cavity 130 is in a door fitting portion 120. The cavity 130 may be configured to receive mechanisms, such as but not limited to locks, bolts, and bolt mechanisms.

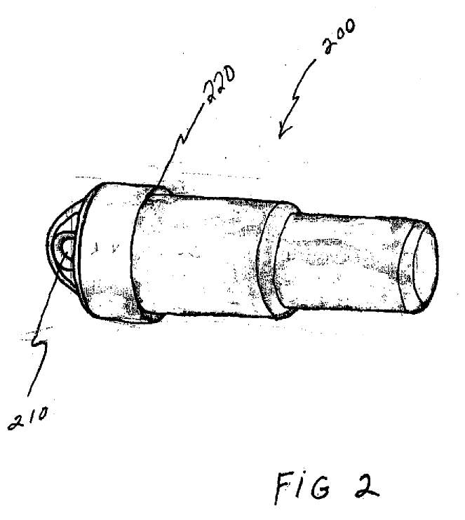

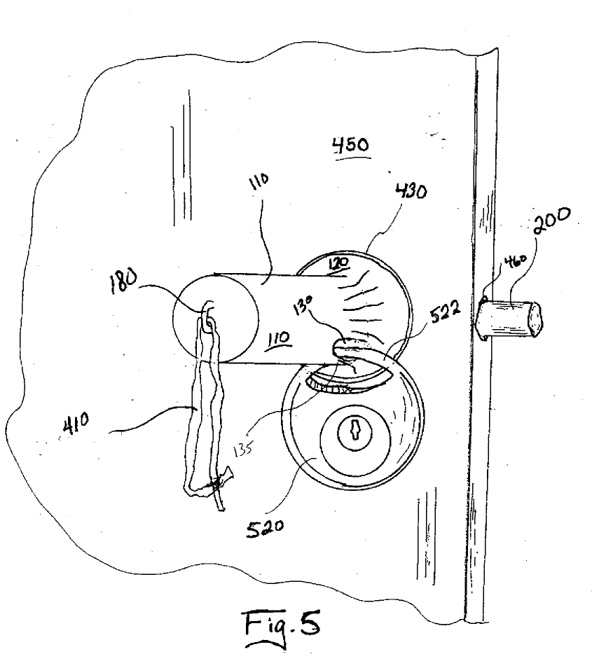

There is also shown a cavity bar 135 defining a portion of the cavity 130. The cavity bar 135 may be configured to provide a feature around which a detachable lock 520 (See FIG. 5) may couple. There is also shown a door fitting slot 140. The door fitting slot 140 may be included in the door fitting portion 120. The illustrated door fitting slot 140 includes a ridge 142 and may be configured to accommodate mechanisms and/or portions of a door hole that may be non-cylindrical and/or non-circular. The ridge 142 and door fitting slot 140 may enable proper radial alignment and/or proper longitudinal alignment of the rod-shaped member 100. The door fitting slot 140 may enable proper alignment of a bolt 200 (See FIG. 2) and/or may prevent easy removal of a bolt 200.

The illustrated rod-shaped member 100 is configured to fit within a hole in a door. Preferably the rod-shaped member 100 is configured to fit within a standard sized hole drilled into doors for the purpose of installing locks. The rod-shaped member 100 may be configured to fit snugly within a standard sized door hole. The rod-shaped member 100 may have a circular, ellipsoid, oval, rectangular, irregular, polygonal, etc. cross section that may correspond to a door hole. The rod-shaped member 100 may be longer than a width of the rod-shaped member 100 or may be equal to or shorter than a width of the rod-shaped member 100.

The rod-shaped member 100 may be made of a great variety of materials. In one embodiment, the rod-shaped member 100 is constructed including a durable rigid material. The rod-shaped member 100 may include wood, metal, composite, resin, fiber, polymer, ceramic, and/or any other durable and/or rigid material. The rod shaped member 100 may include more than one material.

The rod-shaped member 100 may be oblong and/or may be sufficiently long to extend through a hole or lock body hole 430 (See FIG. 4) in a door or door blank 450 (See FIG. 4) configured to be disposed in a door frame. The rod-shaped member 100 may be sufficiently long to extend through a lock body hole 430 in a door 450 and simultaneously extend outward substantially perpendicular from the door 450. The rod-shaped member 100 preferably is sufficiently long to extend outward from a door 450 enough to provide a gripping surface large enough to accommodate one or two human hands. This structure may be a handle. There may be a second handle extending out from a second side of the door 450.

The rod-shaped member 100 may have an exterior surface configured to enable gripping of the rod-shaped member 100. In one embodiment, the rod-shaped member 100 may have an outer surface comprising a material including properties that enhance friction between a hand and the rod-shaped member 100. For example, and not as limitation, the outer surface may include rubber, plastic, and/or any other polymer. The rod-shaped member 100 may have an outer surface shaped to enhance gripping of the rod-shaped member 100. There may be ripples, hand grips, one or more longitudinal ridges, circumferential ridges, and/or any other structures/shapes known in the art to enhance grippability of an object, particularly a rod-shaped object.

There may be a multiplicity of ribs 150 defining an outer shape of the rod-shaped member 100. The ribs 150 may have cavities 160 therebetween. Such ribs and cavities 160 may beneficially enhance gripping and/or reduce a weight of the second elongated member 100.

There is shown a sloping section 170 configured to transition the handle portion 10 to the door fitting portion 120. The sloping section advantageously provides a radial transition between the first and second ends 120 and 110 without having any sharp corners that may damage a door blank and/or a user.

There is shown an eye or eyelet 180 configured to receive member(s) coupled thereto, such as, but not limited to elongated flexible materials 410 (See FIG. 4), such as leather strips or thongs. The eyelet 180 may provide an anchoring portion for attachment and/or storage of one or more accessories.

There may be a flange 190 at an end of the rod-shaped member 100. The flange 190 may be with a larger radius than a hole in a door. The flange 190 may be configured with a larger radius than a standard sized hole in a door. The flange 190 may prevent the rod-shaped member 100 from passing through a lock body hole 430 (See FIG. 4) in a door 450 (See FIG. 4).

The rod-shaped member 100 may include a door locking mechanism 520 (See FIG. 5). The door locking mechanism 520 may be configured to function while the rod-shaped member 100 is within a lock body hole 430. The locking mechanism 520 may include a bolt 200 that may be configured to extend through a bolt hole or latch hole 460 (See FIG. 4) in a door 450 (See FIG. 4) and extend into a receiving hole in a door frame as is commonly practiced in the art of doors. The locking mechanism 520 may include an outer face on the rod-shaped member 100 that may be configured to enable locking and unlocking of the door. Locking and unlocking of the door may be by means of a key or by any other means for triggering locking and/or unlocking known in the art.

The locking mechanism 520 may include an actuating member (not shown), such but not limited to a button, lever, dial, etc., configured to trigger locking and/or unlocking the door and may be integral the rod-shaped member 100. The actuating member may be positioned on a handle portion 110 of the rod-shaped member 100. The actuating member may be a lever, a slide, a button, and/or any other mechanism known in the art to trigger or actuate a locking mechanism 520. Locking may be accomplished by installing the rod-shaped member 100 in a hole in a door 450 thereby forcing a bolt or first elongated member 200 through a bolt hole 460 in the door 450 and into a bolt receiving hole in a door frame.

In one embodiment, the bolt 200 is separate from the rod-shaped member 100 and only adjacent the rod-shaped member 100 when the rod-shaped member 100 is in the lock body hole 430 in the door 450. The bolt 200 may be permitted to withdraw from the receiving hole in the frame when the rod-shaped member 100 is removed at car least partially from the door 450.

There may be a threading device 410 (See FIG. 4) coupled to the rod-shaped member 100. The threading device 410 may be configured to facilitate installation of the rod-shaped member 100 in a door. The threading device 410 may be coupled to an end of the rod-shaped member 100. The threading device 410 may be thinner than the rod-shaped member 100. The threading device 410 may be flexible. The threading device 410 may be a wire, may be a leather strip, may be a plastic strip, may be a doubled strip, and/or may be a loop. The threading device 410 may be any means configured to facilitate inserting the rod-shaped member 100 into a hole in a door.

There may be a fitting mechanism (not shown). The fitting mechanism may enable a user to adjust a property of an embodiment of the invention to enhance fitting the embodiment in a hole in a door. The fitting mechanism may adjust an effective radius of a rod-shaped member 100 or a portion thereof by actuation or otherwise. The fitting mechanism may include a bladder, a wedge, a screw, a lever, and/or any other structure known in the art to enhance the fit of an object within a hole. Such may be coupled to any surface of a rod-shaped member 100, thereby enabling alteration of a cross-section of the rod-shaped member 100.

In one embodiment of the invention there may be one or more safety features. A safety feature may include a design, a paint color, a flexibility of a portion of an embodiment, a release mechanism, and/or a securing device. There may also be a decorative portion that may include a design, a color, a label, a mark, a translucent member, a transparent member, and/or a decorative feature and/or structure.

In one embodiment there may be a modular configuration of one or more components, features, options, elements, and/or portions of the embodiment. There may be one or more sizes and/or configurations for one or more of the modular configurations or modular components.

Looking to FIGS. 4 and 5, in operation of one embodiment of the invention, there may be a kit provided including one or more of the portions, objects, features, etc. described herein. A user may thread a threading member 410 that is attached to an eye 180 of a rod-shaped member 100 through a hole 430 in a door 450 in a direction from an inside of a room to an outside of a room intended to be locked from the outside, thereby securing valuables, such as construction tools, therein. A bolt 200, for example an adjustable bolt, may be detached from a keychain and inserted in a bolt hole 460 in a door 450. The door 450 may then be closed. The rod-shaped member 100 may be pulled into the door hole 430 from the inside of the room by the threading member. The rod-shaped member 100 may be aligned with the bolt 200. The bolt 200 may be pushed further through the latch hole 460 and into a bolt hole in the frame of the door 450, thereby securing the door 450 in a shut position. The rod-shaped member 100 may be pulled outwards till a flange 190 of the rod-shaped member 100 abuts the surface of the door, thereby restricting any further outward motion of the rod-shaped member 100. A padlock 520 or other locking mechanism may be attached by a locking rod 522 about a cavity bar 135 and through a cavity 130 in the rod-shaped member 100 and locked. Thereby a door 450 may be locked. Such may be done as a temporary lock during construction of a facility, such as but not limited to locking an otherwise accessible area for the night to protect tools and/or raw materials.

In operation of one embodiment, a rod-shaped member 100 may be inserted into a lock body hole 430 of a door 450. The rod-shaped member 100 may be passed through the door hole till a flange 190 abuts a surface of the door, restricting further motion of the rod-shaped member 100. A person may grip the rod-shaped member 100, thereby enhancing grip of the door 450.

FIG. 2 shows a side perspective view of a bolt 200 according to one embodiment of the invention. The bolt 200 illustrated may be a telescoping bolt 200. Thereby the bolt 200 may be adjustable. The bolt 200 may also include an attachment eye 210 for attaching a mechanism to the bolt 200. For example, without limitation, the attachment eye 210 may attach to a keychain of a user. There may be a lip portion 220 configured to mate with a ridge 142 (See FIG. 1) of a slot 140 (See FIG. 1), thereby securely coupling the bolt 200 to the rod-shaped member 100.

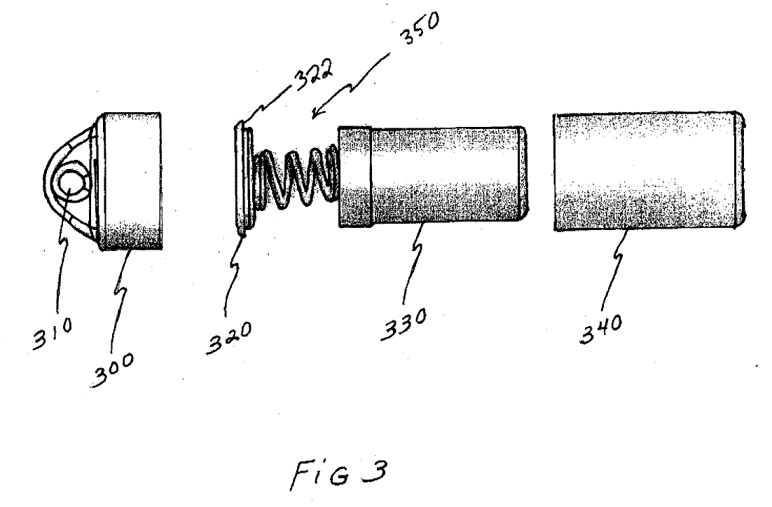

FIG. 3 shows an exploded view of a bolt 200 according to one embodiment of the invention. There is a base portion 300 including an eye 310 configured for attachment, for example to a keychain. The base portion may be detachable from the bolt 200. There is a cap portion 320 that may include a cap flange 322. There is a first telescoping member 330 and a second telescoping member 340. The first telescoping member 330 is configured to fit within the second telescoping member 330. A spring 350 may be internal the bolt 200 and may provide force to extend the telescoping members 330 and 340 to an adjustable desired length. Thereby a single bolt 200 may be used in a variety of doors and/or frame configurations.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is expected that there could be numerous variations of the design of this invention. Finally, it is envisioned that the components of the device may be constructed of a variety of materials. There may be metal, fiber, resin, wood, plastic, polymer, ceramic, composite, and/or mineral.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A removable door locking system, comprising:
a) a door blank configured to be disposed in a door frame, the door blank having:
a1) a lock body hole through the door blank and configured to receive a lock body; and
a2) a latch hole through the door blank and in communication with the lock body hole;
b) a first elongated member configured to pass through the latch hole and extend therefrom;
c) a second elongated member disposable in the lock body hole and configured to extend therefrom, the elongated member having;
c1) a first end shaped to substantially prevent egress of the first elongated member from the latch hole through the lock body hole when the first end is disposed in the lock body hole; and
c2) a second end disposable through the lock body hole;
d) a flange extending radially from the first end of the elongated member and configured to stop passage of the first end through the lock body hole of the door;
e) an aperture through the second elongated member; and
f) a detachable lock coupleable to the aperture and configured to stop passage of the second end through the lock body hole when coupled to the aperture.

2. The removable door locking system of claim 1, further comprising a flexible member coupled to the second end and configured to facilitate threading the second elongated member through the lock body hole.

3. The removable door locking system of claim 1, further comprising a door fitting slot disposed on an exterior surface of the first end.

4. The removable door locking system of claim 1, wherein the first elongated member comprises a plurality of telescoping members disposable in an extended and a retracted position.

5. The removable door locking system of claim 4, wherein the first elongated member further comprises a spring disposed within the plurality of telescoping members, the spring configured to bias the telescoping members in the extended position.

6. The removable door locking system of claim 1, wherein the second elongated member includes an eyelet configured to enable attachment.

7. A lock and carry kit for carrying and temporarily locking a door blank having a lock body hole and a latch hole, the kit comprising:
a) a first elongated member configured to pass through the latch hole and extend therefrom;
b) a second elongated member disposable in the lock body hole and configured to extend therefrom, the elongated member having:
b1) a first end shaped to substantially prevent egress of the first elongated member from the latch hole through the lock body hole when the first end is disposed in the lock body hole; and
b2) a second end disposable through the lock body hole;
c) a flange extending radially from the first end of the elongated member and configured to stop passage of the first end through the lock body hole of the door;
d) an aperture through the elongated member; and
e) a detachable lock coupleable to the aperture and configured to stop passage of the second end through the lock body hole when coupled to the aperture.

8. The lock and carry kit of claim 7, further comprising a flexible member coupled to the second end and configured to facilitate threading the second elongated member through the lock body hole.

9. The lock and carry kit of claim 7, further comprising a door fitting slot disposed on an exterior surface of the first end.

10. The lock and carry kit of claim 7, wherein the first elongated member comprises a plurality of telescoping members disposable in an extended and a retracted position.

11. The lock and carry kit of claim 10, wherein the first elongated member further comprises a spring disposed within the plurality of telescoping members, the spring biasing the telescoping members in the extended position.

12. The lock and carry kit of claim 7, wherein the first elongated member includes an eyelet configured to enable attachment.

13. The lock and carry kit of claim 11, wherein the second elongated member includes an eyelet configured to enable attachment.

14. The lock and carry kit of claim 13, further comprising a flexible member coupled to the eyelet and configured to facilitate threading the second elongated member through the lock body hole.

15. The lock and carry kit of claim 14, wherein the first elongated member includes an eyelet.

16. The lock and carry kit of claim 15, further comprising a door fitting slot disposed on an exterior surface of the first end.

17. The lock and carry kit of claim 16, wherein the second elongated member further comprises a plurality of ridges configured to enhance gripping.

18. A lock and carry kit for carrying and temporarily locking a door blank having a lock body hole and a latch hole, the kit consisting essentially of:
a) a first elongated member configured to pass through the latch hole and extend therefrom;
b) a second elongated member disposable in the lock body hole and configured to extend therefrom, the elongated member having:
b1) a first end shaped to substantially prevent egress of the first elongated member from the latch hole through the lock body hole when the first end is disposed in the lock body hole;
b2) a second end disposable through the lock body hole; and
b3) an eyelet disposed on the second end;
c) a flange extending radially from the first end of the elongated member and configured to stop passage of the first end through the lock body hole of the door;
d) an aperture through the elongated member;
e) a flexible member coupled to the eyelet and configured to facilitate threading the second elongated member through the lock body hole.; and
f) a detachable lock coupleable to the aperture and configured to stop passage of the second end through the lock body hole when coupled to the aperture.

19. The lock and carry kit of claim 18, wherein the first elongated member comprises a plurality of telescoping members disposable in an extended and a retracted position.

20. The lock and carry kit of claim 19, wherein the first elongated member further comprises a spring disposed within the plurality of telescoping members, the spring biasing the telescoping members in the extended position.
